(19) United States
(12) Patent Application Publication
(10) Pub. No.: US 2010/0112420 A1
(43) Pub. Date: May 6, 2010

(54) Internal pressure measuring apparatus for secondary battery

(76) Inventor: Chang-Keun Back, Suwon-si (KR)

Correspondence Address: LEE & MORSE, P.C., 3141 FAIRVIEW PARK DRIVE, SUITE 500, FALLS CHURCH, VA, 22042, US

(21) Appl. No.: 12/588,934

(22) Filed: Nov. 3, 2009

(30) Foreign Application Priority Data
Nov. 3, 2008 (KR) 10-2008-0108414

(51) Int. Cl. H01M 10/48

(52) U.S. Cl. 429/90

(57) ABSTRACT

An internal pressure measuring apparatus for a secondary battery includes a connection jig configured to be fastened to an electrolyte inlet port of the secondary battery, a pressure gauge displaying a measured internal pressure, and a pipe connecting the connection jig to the pressure gauge and filled with a pressure medium.

### BACKGROUND OF THE INVENTION

1. Field of the Invention

Embodiments relate to an internal pressure measuring apparatus for a secondary battery, and more particularly, to an internal pressure measuring apparatus for a secondary battery capable of measuring internal pressure variation of a secondary battery in real time based on external environments after injection of an electrolyte.

2. Description of the Related Art

In recent times, compact and lightweight mobile electric/electronic appliances, e.g., cellular phones, notebook computers, camcorders, etc., have been widely developed and manufactured. In order to operate the mobile electric/electronic appliances even when there is no separate power supply available, a battery pack is built-in. The battery pack may include, e.g., a nickel-cadmium (Ni—Cd) battery, a nickel-hydrogen (Ni-MH) battery, or a lithium (Li) battery. In consideration of economic feasibility, the battery pack may generally be a secondary battery, which can be repeatedly charged and discharged.

The lithium (Li) secondary battery is widely used for the mobile electric/electronic appliances because of the advantages the lithium secondary battery has over the Ni—Cd battery and the Ni-MH battery. The lithium secondary battery has an operation voltage about three times larger than that of the Ni—Cd battery or the Ni-MH battery. Also, the lithium secondary battery has energy density per unit weight, which is larger than that of the Ni—Cd battery or the Ni-MH battery. The lithium secondary battery may be classified based on the kind of electrolyte, e.g., a lithium ion battery using a liquid electrolyte or a lithium polymer battery using a polymer electrolyte. The lithium secondary battery may be further classified based on the shape thereof, e.g., a cylinder type battery, a prismatic type battery, or a pouch type battery.

The secondary battery generally includes an electrode assembly, a can containing an electrolyte in which lithium ions can move between electrodes of the electrode assembly, and a cap assembly for sealing the can. The electrode assembly includes a positive electrode plate having a positive electrode collector with positive electrode active materials applied thereto and a positive electrode tab electrically connected to one side of the positive electrode collector. The electrode assembly further includes a negative electrode plate having a negative electrode collector with negative electrode active materials applied thereto and a negative electrode tab electrically connected to one side of the negative electrode collector. A separator may be disposed between the two electrode plates in the electrode assembly.

Since the secondary battery is completed by coupling the cap assembly to the can where the electrode assembly is housed, injecting an electrolyte through an electrolyte inlet port of the cap assembly, and then, sealing the electrolyte inlet port, it is difficult to measure internal pressure variation of the secondary battery based on external environments when the electrolyte is injected.

### SUMMARY OF THE INVENTION

Embodiments are therefore directed to an internal pressure measuring apparatus for a secondary battery capable of measuring internal pressure variation of the secondary battery based on external environments when an electrolyte is injected.

It is therefore a feature of an embodiment to provide an internal pressure measuring apparatus for a secondary battery capable of precisely measuring the internal pressure of the secondary battery.

It is therefore another feature of an embodiment to provide an internal pressure measuring apparatus for a secondary battery capable of measuring internal pressure variation of the secondary battery in real time based on external environments when an electrolyte is injected.

At least one of the above features and other advantages may be realized by providing an internal pressure measuring apparatus for a secondary battery including a connection jig configured to be fastened to an electrolyte inlet port of the secondary battery, a pressure gauge displaying a measured internal pressure and a pipe connecting the connection jig to the pressure gauge and filled with a pressure medium.

The connection jig may include a projection configured to be inserted into the electrolyte inlet port. The connection jig may further include a sealing member surrounding the projection. The sealing member may be an insulator.

The projection may have a length shorter than a distance between the electrolyte inlet port of the secondary battery and an insulating case inside of the secondary battery. The length of the projection may be longer than a thickness of the cap plate of the secondary battery. The projection may have a spiral cone shape.

A fastening member may be disposed between the pressure gauge and the pipe and may adjust a fastening force between the pressure gauge and the pipe.

A storage medium may be electrically connected to the pressure gauge and may record the measured internal pressure. A display device may be electrically connected to the pressure gauge and may display an internal pressure variation of the secondary battery. The pressure medium may be fluid. The fluid may be oil.

### BRIEF DESCRIPTION OF THE DRAWINGS

The above and other features and advantages of the present invention will become more apparent to those of ordinary skill in the art by describing in detail exemplary embodiments thereof with reference to the attached drawings, in which:

FIG. 1 illustrates a schematic cross-sectional view of an internal pressure measuring apparatus for a secondary battery in accordance with an exemplary embodiment of the present invention.

### DETAILED DESCRIPTION OF THE INVENTION

Korean Patent Application No. 10-2008-0108414, filed on Nov. 3, 2008, in the Korean Intellectual Property Office, and entitled: “Internal Pressure Measuring Apparatus for Secondary Battery,” is incorporated by reference herein in its entirety.

The present invention will now be described more fully hereinafter with reference to the accompanying drawings, in which exemplary embodiments of the invention are shown. This invention may, however, be embodied in different forms and should not be construed as limited to the embodiments set forth herein. Rather, these embodiments are provided so that this disclosure will be thorough and complete, and will fully convey the scope of the invention to those skilled in the art. In the drawings, the length and thickness of layers and regions are exaggerated for clarity, and like reference numerals designate like elements throughout the specification. In addition, when a portion is described to be “connected” to the other portion, it means that the portion may be “directly connected” to the other portion, or may be “electrically connected” to the other portion with another device interposed therebetween.

### Embodiments

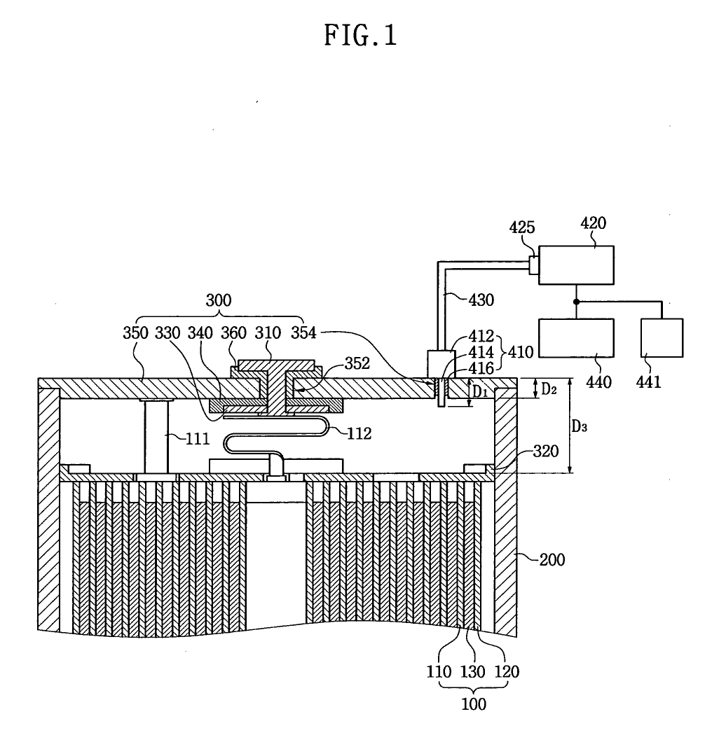

FIG. 1 illustrates a schematic cross-sectional view of an internal pressure measuring apparatus for a secondary battery in accordance with an exemplary embodiment of the present invention.

Referring to FIG. 1, the internal pressure measuring apparatus for a secondary battery in accordance with an exemplary embodiment of the present invention may include a connection jig 410 fastened to an electrolyte inlet port 354 of the secondary battery, a pressure gauge 420 measuring an internal pressure of the secondary battery, and a pipe 430 filled with a pressure medium, connecting the connection jig 410 to the pressure gauge 420.

The secondary battery may include an electrode assembly 100, a can 200 containing an electrolyte (not shown) in which lithium ions can move between electrodes of the electrode assembly 100 and having an upper opening, and a cap assembly 300 sealing the can 200 and having an electrode terminal 310 electrically connected to the electrode assembly 100. The electrode assembly 100 may include a positive electrode plate 120 having a positive electrode tab 111 connected to a positive electrode collector (not shown) with positive electrode active materials (not shown) applied thereto, a negative electrode plate 110 having a negative electrode tab 112 connected to a negative electrode collector (not shown) with negative electrode active materials (not shown) applied thereto, and a separator 130 disposed between the positive electrode plate 120 and the negative electrode plate 110.

The cap assembly 300 coupled to the upper opening of the can 200 may include a cap plate 350, an insulating plate 340, a terminal plate 330, an insulating case 320, and the electrode terminal 310. The cap plate 350 may be a metal plate having a size and shape corresponding to the upper opening of the can 200, and may include a predetermined size of terminal hole 352, an electrolyte inlet port 354, and a safety vent (not shown).

The electrolyte inlet port 354 is a hole through which an electrolyte for smoothly moving lithium ions is injected into the can 200 housing the electrode assembly 100. After coupling the cap assembly 300 to the can 200, the electrolyte may be injected through the electrolyte inlet port 354, and the electrolyte inlet port 354 may be sealed with an electrolyte inlet port cap (not shown), thereby sealing the can 200.

The terminal hole 352 is a hole through which the electrode terminal 310 is inserted. The terminal electrode 310 may be electrically connected to the terminal plate 330 disposed under the cap plate 350 through the terminal hole 352. In order to insulate the electrode terminal 310 from the cap plate 350, a gasket 360 formed of rubber or a non-conductive material having good insulating characteristics may be disposed at an outer side of the electrode terminal 310.

The connection jig 410 may be fastened to the electrolyte inlet port 354 of the secondary battery to transmit the pressure in the secondary battery to the fluid filled in the pipe 430. The connection jig 410 may include a main body 412 adhered to the electrolyte inlet port 354, a projection 414 inserted into the electrolyte inlet port 354 of the secondary battery, and a sealing member 416 surrounding the projection 414 and sealing the electrolyte inlet port 354.

The projection 414 may have a spiral cone shape to be readily inserted into the electrolyte inlet port 354. In order to more precisely measure the internal pressure of the secondary battery based on external environments after sealing the electrolyte inlet port 354 with the electrolyte inlet port cap, the projection 414 may pierce through the electrolyte inlet port cap.

The projection 414 may have a length D1 longer than a thickness of the cap plate D2 of the secondary battery to readily measure the internal pressure of the secondary battery. Since the projection 414 may cause damage to the insulating case 320 and the electrode assembly 100 by being in contact with the insulating case 320 of the secondary battery, the projection 414 may have the length D1 shorter than a distance D3 between the electrolyte inlet port 354 and the insulating case 320.

The pipe 430 may be filled with a pressure medium to measure the internal pressure of the secondary battery without discharging gas filled in the secondary battery and to transmit internal pressure variation of the secondary battery in real time. The pressure medium filled in the pipe 430 may be fluid such as oil. In consideration of factors, i.e., heat in both inside and outside of the secondary battery, the fluid may be a material that is not evaporated or pressure-reduced even above 400° C.

The pressure gauge 420 functions to display the internal pressure of the secondary battery transmitted by the pressure medium filled in the pipe 430. The pressure gauge 420 may further include a fastening member 425 to control a fastening between the pressure gauge 420 and the pipe 430. In order to measure the internal pressure of the secondary battery, the pressure medium, such as fluid in the pipe 430, may need to be readily introduced or exchanged. Thus, after the fastening member 425 loosens the fastening of the pipe 430 and the pressure gauge 420, air remaining in the pipe 430 may be discharged from between the pipe 430 and the pressure gauge 420 to facilitate filling of the pipe 430 with the pressure medium. The pressure medium may be introduced into the pipe 430 through the connection jig 410.

The internal pressure measuring apparatus for a secondary battery in accordance with an exemplary embodiment of the present invention may include a storage medium 440 electrically connected to the pressure gauge 420 to record or store variation in internal pressure of the secondary battery, and may further include a display device 441 to display the variation in internal pressure of the secondary battery.

As described above, in the internal pressure measuring apparatus for a secondary battery in accordance with an exemplary embodiment of the present invention, the connection jig may be fastened to the electrolyte inlet port, and the pipe may be connected between the connection jig and the pressure gauge, so that may be possible to measure the internal pressure of the secondary battery as the internal pressure varies based on external environments in real time.

In addition, the pipe may be filled with a pressure medium such as fluid to measure the internal pressure of the secondary battery without discharging the gas filled in the secondary battery, thereby precisely measuring the internal pressure of the secondary battery.

As can be seen from the foregoing, since an internal pressure measuring apparatus for a secondary battery may measure the internal pressure of the secondary battery transmitted by a pressure medium such as fluid filled in a pipe connected between a pressure gauge and a connection jig fastened to an electrolyte inlet port, it may be possible to measure variation in internal pressure of the secondary battery in real time.

Exemplary embodiments of the present invention have been disclosed herein, and although specific terms are employed, they are used and are to be interpreted in a generic and descriptive sense only and not for purpose of limitation. Accordingly, it will be understood by those of ordinary skill in the art that various changes in form and details may be made without departing from the spirit and scope of the present invention as set forth in the following claims.

What is claimed is:

1. An internal pressure measuring apparatus for a secondary battery, comprising:
a connection jig configured to be fastened to an electrolyte inlet port of the secondary battery;
a pressure gauge displaying a measured internal pressure; and
a pipe connecting the connection jig to the pressure gauge and filled with a pressure medium.

2. The apparatus as claimed in claim 1, wherein the connection jig includes a projection configured to be inserted into the electrolyte inlet port.

3. The apparatus as claimed in claim 2, wherein the connection jig further comprises a sealing member surrounding the projection.

4. The apparatus as claimed in claim 3, wherein the sealing member is an insulator.

5. The apparatus as claimed in claim 2, wherein the projection has a length shorter than a distance between the electrolyte inlet port of the secondary battery and an insulating case inside of the secondary battery.

6. The apparatus as claimed in claim 5, wherein the length of the projection is longer than a thickness of the cap plate of the secondary battery.

7. The apparatus as claimed in claim 2, wherein the projection has a spiral cone shape.

8. The apparatus as claimed in claim 1, further comprising a fastening member disposed between the pressure gauge and the pipe and adjusting a fastening force between the pressure gauge and the pipe.

9. The apparatus as claimed in claim 1, further comprising a storage medium electrically connected to the pressure gauge and recording the measured internal pressure.

10. The apparatus as claimed in claim 1, further comprising a display device electrically connected to the pressure gauge and displaying variation in internal pressure of the secondary battery.

11. The apparatus as claimed in claim 1, wherein the pressure medium is fluid.

12. The apparatus as claimed in claim 11, wherein the fluid is oil.
